(19) United States
(12) Patent Application Publication
(10) Pub. No.: US 2015/0127430 A1
(43) Pub. Date: May 7, 2015

(54) METHOD AND SYSTEM FOR IDENTIFYING ITEMS AND MANAGING A COLLECTION OF ITEMS

(71) Applicant: Statimate Systems Inc., Greensburg, PA (US)

(72) Inventor: Edgar T. Hammer, III, Greensburg, PA (US)

(21) Appl. No.: 14/529,928

(22) Filed: Oct. 31, 2014

Related U.S. Application Data
(60) Provisional application No. 61/899,393, filed on Nov. 4, 2013.

(51) Int. Cl. G06Q 30/02; G06Q 10/08

(52) U.S. Cl. CPC G06Q 30/0206; G06Q 10/087
USPC 705/7.35

(57) ABSTRACT

A system for identifying, and managing a collection of items by receives an image or images of a target object, identifies, assists in valuation of and catalogs the object by using computer vision to extract identifying characteristics of the target object from the image or images, searching a data set of items to identify a probable match, and retrieving its stored identification and valuation. If no probable match is found, or if the match probability is below a threshold, the system may send the image to other users to help identify and value the item via crowdsourcing. It will then return the identification and valuation data to the requesting user and update its data set to include the crowdsourced data. The system also may store data relating to individual user collections based on data that it receives in this manner.

### RELATED APPLICATIONS AND CLAIM OF PRIORITY

This patent document claims priority to U.S. provisional patent application No. 61/899,393, filed Nov. 4, 2013, titled “Method and System for Identifying, Valuing and Cataloging Collectible Items.” The disclosure of the priority application is hereby incorporated by reference in its entirety.

### BACKGROUND

This document relates to methods and systems for identifying, cataloging and managing collections of items such as coins, stamps, books, trading cards, figurines, antiques and jewelry. This document also describes methods and systems for valuing such items.

Millions of people who are not professional collectors find themselves in possession of, or with an opportunity to purchase or sell, items that they suspect are valuable, such as coins, stamps, guns, antiques, buttons or other collections of items of any type or sort, but for which they lack the expertise, knowledge or time to value themselves. This is particularly common when someone passes and the survivors inherit items and collections that they know nothing about. At other times, it's just good fortune, such as when someone receives change after a purchase and notices a coin that they suspect is old and probably worth more than face value.

Identifying and valuing items is only part of the challenge for collectors. If a collector has a large number of items, the collector often desires to catalog everything and may need to do so for estate settlement, insurance, prior to giving to someone else for appraisal, or numerous other reasons. Although this can be done with current software applications, such as spreadsheets and databases, it can be very time consuming and a challenge to manually research what each item is, research values or obtain appraisals, enter all the relevant information, keep it updated it over time with current valuations, or share it with others. This is especially true for non-collectors who may have little or no expertise in doing the above, but it is likewise an effort for the seasoned collector.

In summary, there is not a simple way for the typical collector for collectors or non-collectors to rapidly identify and get an estimated value of an item, or to catalog a collection of items. This document describes methods and systems that are directed to solving at least some of the problems described above.

### SUMMARY

A system for identifying items and managing a collection of items receives an image of a target object, extracts identifying characteristics of the target object, and returns a probable match and estimated value for the target object. The system may search a database of items to identify an item that is a probable match for the target object. In addition, or alternatively, the system may send the image to a set of users to help identify the item in a crowdsourcing manner. When the item is identified, either by the system or the crowdsourcing community, the system may search the database and determine whether valuation data is available for the item. In addition or alternatively, it may send a request to the crowdsourcing community and/or expert appraisers for valuation data for the item. It will then return the valuation data to the requesting user and/or update its database to include the valuation data. The system also may store data relating to individual user collections based on data that it receives in this manner. The system may also routinely update valuations either upon user request, at regular frequencies and/or when a significant valuation change is observed in similar items being valued by others.

In an embodiment, a system for identifying items and managing a collection of items includes a processor and a first data storage facility portion containing data relating to various items and, for each item, identifying data and categorical data. The system also includes an image processing module comprising a non-transitory computer-readable memory portion containing programming instructions that, when executed by the processor, cause the processor to: (i) receive, from a first user, an image of a target object; (ii) process the image to extract one or more identifying characteristics of the target object; (iii) compare the extracted identifying characteristics with the identifying data in the first data storage facility to attempt to identify one or more items having identifying data that matches at least a threshold portion of the extracted identifying characteristics; and (iv) classify any such identified items as a probable match with the target object. The system also includes an object identification confirmation module comprising a non-transitory computer-readable memory portion containing programming instructions that, when executed by the processor, cause the processor to (if one or more probable match items were identified in the comparing step) return the identifying data for each probable match item to the first user and request that the first user confirm which, if any, of the probable match items corresponds to the target object. If no probable match items are identified in the comparing step, or if the first user does not confirm that any of the probable match items corresponds to the target object, then the object identification confirmation module will cause the system to send the image of the target object to a plurality of additional users for identification, receive crowdsourced identifying data from at least one of the additional users, add at least some of the crowdsourced identifying data to the first data storage facility portion, and return the crowdsourced identifying data to the first user.

In some embodiments, the first data storage facility portion also may include valuation data for at least some of the items. If so, the system also may include an automated appraisal module comprising instructions that, when executed, cause the processor to perform an analysis for a selected one or more of the identified probable match items. The analysis may include: (i) determining whether the first data storage facility portion includes stored valuation data for the selected probable match item; (ii) if the first data storage facility portion includes valuation data for the selected probable match item, returning the stored valuation data to the first user; (iii) sending the image of the target object, the identifying information for the selected probable match item, or both one or more additional users for valuation; (iv) receiving, from at least one of the additional users, crowdsourced valuation data; (v) adding at least some of the crowdsourced valuation data to the first data storage facility portion as new valuation data for the target object; (vi) and returning the crowdsourced valuation data to the first user.

In some embodiments, the instructions of the object identification module also include instructions to receive, from the first user, user-supplied identifying characteristics and user-supplied category information. Then, when identifying the item(s) in the database that are a probable match with the target object, the module may cause the system to also compare the user-supplied identifying characteristics to the identifying data in the first data storage facility to identify one or more items having identifying data that matches at least a threshold portion of the user-supplied identifying characteristics, and also use the user-supplied category information and require that the identified items have categorical data that corresponds to the user-supplied category information.

Optionally, the system may include a second data storage facility portion containing a catalog of first user items that are part of a collection that is associated with the first user. If so, the system may include additional programming instructions that, when executed, cause the processor to add the image, identifying information, and categorical information for the probable match item to the catalog as a catalogued item for the first user upon receipt of the confirmation from the first user that the probable match items corresponds to the target object.

In some embodiments, when the system receives crowdsourced valuation data, the data received may include an appraised value for the target object. If so, then the automated appraisal module also includes instructions that, when executed, cause the processor to: (i) present, to the first user, each of the received appraised values; (ii) receive, from the first user, a selection of one of the received appraised value or an average or mean of each of the appraised values; and (iii) add the user selection to a data set that includes identifying and valuation data for a collection of the objects for the first user.

Optionally, the automated appraisal module also may include programing instructions that cause the processor to implement a messaging function that enables any of the additional users to send the first user a request for supplemental information about the target object, receive the supplemental information in response to the request, and display the supplemental information to the additional user for use in generating the crowdsourced valuation data.

In some embodiments, the system may include a data set comprising a collection of objects that are associated with the user. For each object, the system may include identifying data and valuation data. If so, the system may also include a memory portion containing programming instructions that, when executed, cause the processor to add the crowdsourced identifying and/or valuation data to the data set in association with the target object.

In some embodiments, the automated appraisal module also includes programing instructions that enable an additional user to request the first user to send the actual target object to a delivery address. Prior to delivery of the target object to the delivery address, the system may receive an initial image of the target object. After return of the target object to the first user, the system may receive a final image of the target object. Then, the system may process the initial image and the final image to extract one or more additional characteristics of each image, compare the extracted additional characteristics to the extracted identifying characteristics of the target object to determine whether any differences exist that would indicate that the target object may have been replaced with a different object, and return a report of the comparing to the first user.

In some embodiments, the automated appraisal module may enable appraisers to submit a bid for appraising a target object. After receiving a number of bids, the system may compare the bids to one or more selection criteria, and it may present the bids that meet the selection criteria to the first user.

In additional embodiments, the system may receive an image of a second candidate object from a second user. It may process the image to identify one or more identifying characteristics of the second candidate object, and it may search the database to determine whether any target object in the database has characteristics that match the identifying characteristics of the second candidate object. If one or more target object in the database have characteristics that match the identifying characteristics, the system may return identifying data for each such target object item, along with a history of previous valuation data or ownership data for the target object.

### BRIEF DESCRIPTION OF THE DRAWINGS

FIG. 1 is an illustration of various components of a system for valuing and/or cataloging collectible items.

FIG. 2 illustrates an example of a process flow for the valuation service.

FIG. 3 is an additional description of process flow elements that the system may implement.

FIG. 4 illustrates various user interface elements that may be provided on a user's electronic device by a software application portion of the system.

FIGS. 5 and 6 illustrate example pages of a user interface dashboard.

FIG. 7 illustrates an example page of an appraiser interface dashboard.

FIG. 8 illustrates various hardware components of an example of an electronic device, server and/or computer.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

In this document, an “electronic device” refers to a device that includes a processor and non-transitory, computer-readable memory. The memory may contain programming instructions that, when executed by the processor, cause the electronic device to perform one or more operations according to the programming instructions. Examples of electronic devices include personal computers, servers, mainframes, gaming systems, televisions, and portable electronic devices such as smart phones, personal digital assistants, tablet computers, laptop computers, cameras, media players and the like. At least some electronic devices may include an image capturing sensor such as a camera that can capture images of one or more objects.

“Electronic communication” refers to the ability to transmit data via one or more signals between two or more electronic devices, whether through a wired or wireless network, and whether directly or indirectly via one or more intermediary devices.

When this document uses the term “processor” or “processing device,” unless expressly stated otherwise it is intended to include embodiments that consist of a single data processing device, as well as embodiments that include two or more data processing devices that together perform various steps of a described process.

When this document uses the terms “memory,” “computer-readable memory,” and :computer-readable medium,” unless expressly stated otherwise it is intended to include embodiments that consist of a single memory device, embodiments that include two or more memory that together store a set of data or instructions, or a sector or other portion of a memory device.

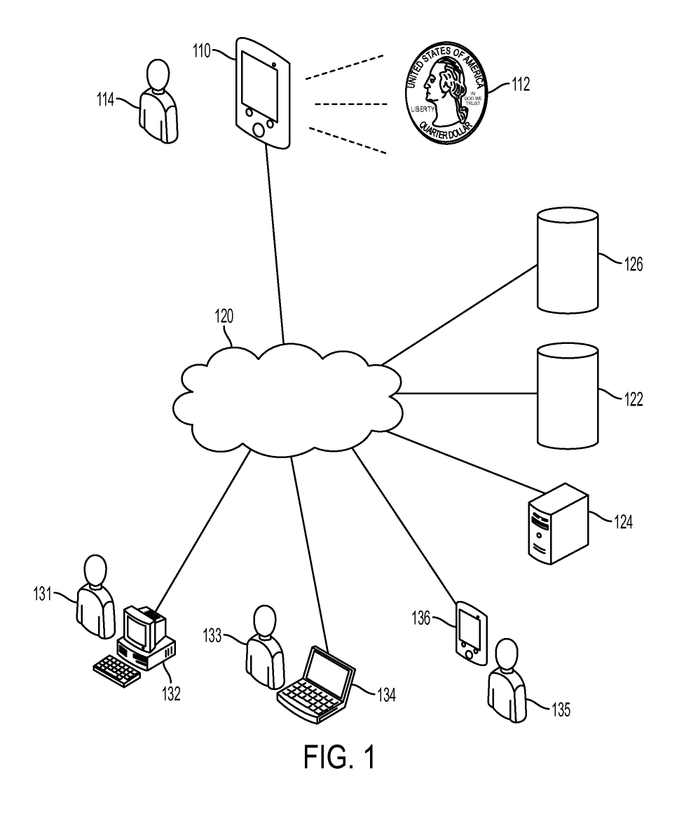

The methods and systems described below provide a tool that may enable an average person to identify, obtain an estimated value for, and catalog an item by doing little more than capturing and uploading a photo of the item. FIG. 1 illustrates various elements of a valuation and cataloguing system. A user 114 will use an electronic device 110 to capture an image of a collectible item 112. The user may be an owner of the item, a person acting on behalf of the owner, an entity that is holding the item, a seller that is working to sell the item, or any other user who has an interest in cataloguing and/or valuing the item. The electronic device may save the captured image file to its memory, and/or it may transmit it to a valuation service via an electronic communications network 120 such as the Internet or a cellular data network. A valuation service will include a valuation server 124 made up of one or more processors and a data storage facility 122 such one or more databases. Thus, the valuation service may itself be considered an electronic device, even if made up of multiple devices.

The data storage facility 122 will include a structured dataset of collectibles data that includes identifying information for collectible items, categorical information about collectible items, and valuation information for various collectible items. In some cases, the data storage facility 122 also may hold one or more image files for each collectible item. Identifying information for a collectible item will include one or more physical characteristics of the item, such as a shape, size or color; text or image content imprinted on the item; a location on the item where text or image content is expected to be imprinted; and/or other information. Categorical information will include one or more data points describing one or more classes to which the item belongs, such as “coin,” “stamp,” “U.S. quarter” or other category. Valuation information will include one or more data points representing one or more financial values for the item.

Optionally, the stored information for any given item may include more than one type of identifying information, more than one category, or more than one financial value. For example, an item may have various financial values that are associated with various conditions, so that an item that is in mint or good condition may have a higher value than would be associated with an item that is in fair or poor condition. In addition, the data may include a range of financial values over time, which together may represent appreciation or depreciation of an item's value. The data also may include multiple financial values for a single item as provided by various users of the system who provided appraisals of the item's value.

The valuation service, and/or a software application running on an electronic device, may analyze the image and extract one or more features relating to the target object in the captured image. An image processing module that includes programming that instructs a processor and corresponding hardware to perform any suitable computer visioning process, such as OpenCV, may be used for this purpose. The user's electronic device 110 may transmit the image file via the network 120 to the valuation service's processor 124 for analysis by implementation of an image processing module. Or, if the electronic device includes the image processing module and analyzes the image, the device may transmit the resulting identifying information to the processor 124. In addition, an application running on the electronic device 110 may enable the user to enter additional information that is then transmitted to the processor 124. The additional information may include, for example, identifying information about the target object, categorical information about the target object or information relating to the item's condition (e.g., good, fair or poor).

The processor 124 will implement the image processing module by comparing the extracted features and optional additional information to identifying information in the database and attempt to find an item in the data storage facility that is a probable match with the target object. Probable matches are those items in the data storage facility 120 having at least a threshold number of identifying information data points that match the identified features that were extracted from the image. Optionally, to be a probable match, the system may require that the stored data also match additional user-supplied data, such as categorical information. If the item identifies one or more probable matching item, it may return to the user's electronic device 110 via the network 124 categorical information and (if available) one or more stored images for each probable matching item. Optionally, if available the valuation may return the valuation information for each probable matching item. Alternatively, the valuation service may require the electronic device's user 114 to verify that the probable matching item is an actual match before the valuation service will return valuation data.

The device and/or the valuation service also may include programming for an object identification confirmation module that helps it verify or determine the identification of an object. If only one item is a probable matching item, the application running on the electronic device 110 may ask the user 114 to provide an input indicating whether or not the probable matching item actually matches the target object. If more than one item is a probable matching item, the application may ask the user 114 to select one of the probable matching items for additional data delivery. The valuation service may then return the valuation data to the user's electronic device 110 for the verified item.

Optionally, the user may be required to submit only a photo of the target object, and no other information about it. Alternatively, if there are multiple matching items, or if there is ambiguity in the extracted features of the target object, the valuation service may transmit a message to the first user's electronic device 110 that asks the user 114 to provide additional data to help identify the target object. An application on the electronic device 110 may present the request to the user 114, and the device 110 may transmit the user's response to the valuation service via the network 120. For example, if the extracted data for a target object that is a coin included three digits (e.g., “201”) in a location on the coin where a date is expected to appear, the valuation service may ask the user 114 for the fourth digit to complete the data representing a year (such as “2010”). As another example, the valuation service may ask the user 114 to provide descriptive information (such as a color), or it may ask the user 114 to take and transmit another photo of the target object, such as a photo of a different face or angle of the target object.

If no probable matching items are identified, or if the user 114 does not confirm that any probable matching item is an actual match, or if additional identification information would be helpful, or automatically without checking for a match if programmed to do so, the valuation service's processor 124 may implement additional aspects of the object identification confirmation module by making the image of the target object available to any number of other users' electronic devices 132, 134, 136 as a crowdsourcing service. The users of the other devices 131, 133, 135 may provide the valuation service with identifying information. The valuation service may then store the received crowdsourced information in the data storage facility 132 and/or return it to the first user's electronic device 110 so that the system and/or user 114 can use it to identify the item in the captured image.

In addition, if no valuation data is available in the data storage facility for a probable (or confirmed) match item, or if the valuation data may be outdated (such as at least a threshold number of days old), or of the probability of the match is low (i.e., less than a threshold percentage or other threshold), or if additional valuation information would be helpful, or automatically in each case or based on other criteria, the valuation service may make the image (and optionally identifying information) available to the other electronic devices 132, 134, 136 via the network 120 so that the other users can provide the valuation service with updated valuation information. The valuation service may then store the received crowdsourced valuation data in the data storage facility 122 and return it to the user's electronic device 110.

Crowdsourced identifying information and valuations may be assigned a reliability ranking based on any suitable criteria, such as: (i) user feedback and rating of the users who provided the identifying information and valuations; (ii) user feedback on the provided identifying information and valuations; or (iii) if an item is subsequently sold, comparison of actual selling price against valuation. Any of these factors, or other factors may be used as variables in a calculation (such as a sum) to determine a reliability score for the crowdsourced identifying information and valuation data. Optionally, the system may only present the requesting user 114 with identifying information and valuation data that exceeds at least a minimum threshold score. Additionally, if valuation data is received from a sufficient number of users, the system may present some of the data, all of the data, an average or median of the data, or all of the data excluding outliers such as the highest and lowest values, or some other subset of the data to improve reliability. Optionally the user 114 may be able to limit valuations to specific appraisers, or to appraisers who have achieved at threshold rating. Optionally, the system may require the user to pay for access to certain appraisers, such as professional appraisers or those having at least a threshold rating.

The valuation service and/or a memory on the electronic device may maintain a data collection 126 of collection information for the user 114 and/or other users. The collection information may be searchable by the user, and access to the data in the user's collection may be secured by a passcode or other security protocol.

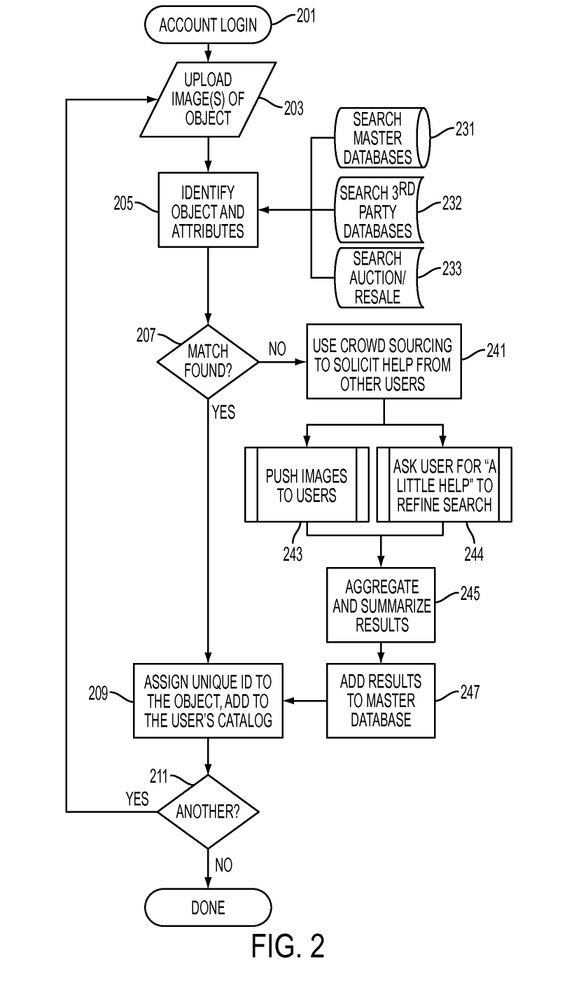

FIG. 2 illustrates an example of a process flow for the valuation service. To use the valuation service, the system may require the user to enter a credential 201 into a user interface of an electronic device. When the system receives the credential, the system may log the user into an account on an installed software application or a remote server. The system with then receive one or more images of an item 203 such as by prompting the user to capture an image of the item with the electronic device, or simply because the user transmitted the image to the system. The system will process the image and apply any suitable computer vision matching algorithm to identify the target object 205 by seeking matching items in one or more reference data set. The system may do this by comparing one or more attributes of the object with attributes of objects in the databases, such as text, numbers or images on the object; shape; color; and other identifying characteristics. The reference data set may include a master database 231 that is hosted by the system and/or one or more third party databases 232. The system may assign a score to the probability of match between the object and a candidate item in the database, such as a percentage of the available characteristics that match. If the score is sufficiently high (such as above a threshold), it may consider the candidate item to be a probable match with the object 207. It will then extract a copy of the data for the candidate item from the database, which data may include identifying data, one or more attributes that help to identify and catalog the object (such as type, year, country of origin, etc.), and valuation data for the item. Optionally, the system also may extract valuation data from one or more captive or third party auction or reseller sites 233 to identify what values others are assigning to the item.

If the system identifies several probable matches, it may present the probable matches to the user who submitted the image to select one of the probable matching items as the actual object. If not, or even if so, the system may send an image of the object and (optionally) one or more of the candidate items to other users and ask the other users to identify the item. 241. The system may push these images via a messaging service or by posting them on a website 243 and receive responses from the user.

Once the system identifies a probable match, the valuation service may implement an appraisal module, which will comprise programming instructions that cause a processor to use any of various methods to provide an estimated value for the target object depending on the identifying, categorical, and/or condition information about item. For example, if the target object is recognized as a coin, the server may query existing grading databases to attempt and auto grade the coin and return an estimated value. For other items, the server may look at auction histories to find what similar items sold for in the past. The target object may be assigned a unique identification code and automatically catalogued in a database for the user along with images, attributes describing the item and estimated values.

In the event that computer vision is not able to classify or identify a target object, or if the system determines that additional information about the object will be helpful, or if the system is programmed to automatically initiate external help in identification or valuation, crowdsourcing will be used to enlist the help of online hobbyists, professionals, appraisal services and even the user to help identify and value items. For example, the system may permit users to provide “a little help” 244 which would be a prompt asking users to provide keywords, metadata or other information that could be helpful to identifying the item.

Crowdsourced identification may be described by way of an example using a coin. In an identification process, the server may be able to use computer vision to recognize that an uploaded image is of a U.S. quarter, but the date is so worn off that the server is unable to read the date using optical character recognition techniques, a sub category of computer vision. The application may prompt the user to provide additional helpful information, such as by asking the user if he or she is able to read and manually enter the date. If the service is still able to find a satisfactory match in any database it may then query the database for the value of U.S. quarter of the given date. In addition or alternatively, it might start pushing images of that U.S. quarter to other users asking the other users to provide valuation. As responses come in, the system may process them (such as by determining an average, median, highest, lowest, etc.) and could use them to provide the requesting user with valuation data and update the database where it would be available for future matching 247. Users may be able to select which valuation they want to assign to their item and/or assign their own valuation.

Several other features may be included in the system. For example, the valuation service may use any now or hereafter known statistical analysis methods to analyze and rank appraisers. This may be based on data such as user rankings of appraisers, the appraiser's consistency in values provided, and/or comparison of actual selling prices against the appraiser's valuations. The system may assign scores to any or all of these data points and then generate an aggregate score, such as by summing, averaging or weighting the scores. Optionally, the system may repeatedly direct similar items or categories of items to a particular appraiser over time to analyze the appraiser's consistency valuing the same item. Appraisers can earn credibility as a reputable, reliable and trustworthy appraiser.

In an embodiment, the system may also compare the accuracy of the appraiser's values as compared to values received from other appraisers. Appraisers who provide appraisals that are at or within a threshold range from a mean or median of received appraisals may receive higher scores, while appraisers whose appraisal values significantly differ from those in the crowd may be given lower scores. Then, when appraisers submit additional values to the system for future items, the system may take the appraiser's scores into account when determining how much weight to give to that appraiser's appraisal.

Various embodiments of the system can also use computer vision to verify that the true identifiers and categories for items provided to an appraiser match the identifiers and categories that appraiser has assigned to the item.

In some embodiments, specific devices can be used to automate the valuation process. For example, a coin counter could be equipped with a digital camera that captures photos of coins as they are received. The coin counter could then include the hardware and software comprising the valuation service, or it may include a transmitter to transmit the image and/or extracted data to an external valuation service so that it may value the coins as they are received.

Once the system identifies an item, it may assign a unique identifier to the item, and save all known data (such as identification data, the image, valuation data and other data) to a data storage facility along with an identification of the user who uploaded the image 209. If the user has submitted an image of another object or otherwise wants to add another object to his or her collection 211, the system may repeat the process described above. In this way, the system saves data about all objects that are in a user's collection to assist the user in tracking and managing a catalog of his or her collection of objects.

Optionally, the system can be used to track ownership paths of collectible items as the items are transferred between subscribers to the service. Once the system assigns a unique ID is assigned to an item, the ID can travel with that item as it is bought and sold. Even if it ends up in the hands of a member who is not a user of the service, the item's digital image, ID, valuation data, ownership history and other details may be archived in the system's data store and recognized by the system in the future if someone else enters it into the system. For example, if a user takes an image of an item, the system may process the image and compare it to archived data to determine whether any item in the database has a matching image. If so, then the system may return and use the ID for the item, and update the ownership history if required to add the current user to the item's ownership history.

The addition of crowdsourcing in the identification process can help to identify damaged or otherwise unidentifiable collectible items, for example, coins, stamps, and other rare collectables may be identified that would have otherwise been melted, tossed or lost to time and deterioration because of the challenges of having them appraised and cataloged. In addition, the computer vision process may recognize multiple items in a single image.

The system could be used with any item, not just collectible items. For example, because of its ability to rapidly identify, value and catalog a variety of items, various embodiments of the service could be a benefit to insurance companies, restoration companies, and others that have a need to identify and catalog, if not value, volumes of items quickly.

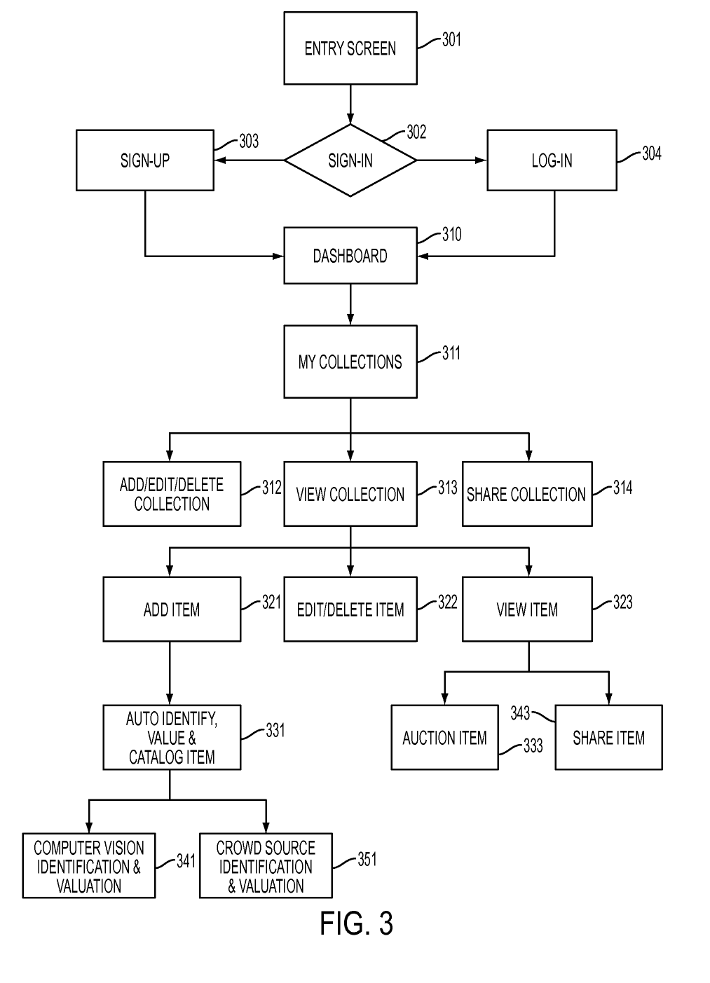

FIG. 3 is a diagram showing various functions that the system may offer to a user to manage a collection of objects. The service may be made available via a web-based service so that the user accesses the service via a web browser, via a mobile application, by another type of downloadable application, or by other means. The system may begin by displaying an entry screen 301 by which the user may sign in 302 by providing authentication information such as a username, password, audio prompt, swipe pattern, biometric identifier or other credential. If the user is not known to the service the service may prompt the user to sign up 303 for an account by entering identifying information and providing an authentication credential by which the service will identify the user.

Once a user is authenticated to the service 304, the system may present the user with a dashboard 310 that includes a home page with activity feed that includes components such as those in FIG. 3. The feed may include one or more collections 311 of objects that the user has added to the data set so that the user and/or system can use the collections to group items of the same category or similar categories together. The system may include user-selectable inputs that permit a user to view a collection 313; add, edit or delete a collection from the user's catalog 312; or share the collection 314 with other users or with users of an external service such as a social media site. When the user views a particular collection 313, the system also may provide user-selectable prompts for adding an item 321 using identification and cataloging processes 331, along with computer vision 341 and crowdsourced identification and valuation 351 processes such as those described above for FIG. 2. The system may also include fields by which the user may edit information about an item or delete an item 322 from his or her catalog. Or, the user may simply view an item 323 and its corresponding stored valuation or other data, as well as share information about a 343 particular item with other users or make an item from the user's collection available for sale 333 such as via an auction process.

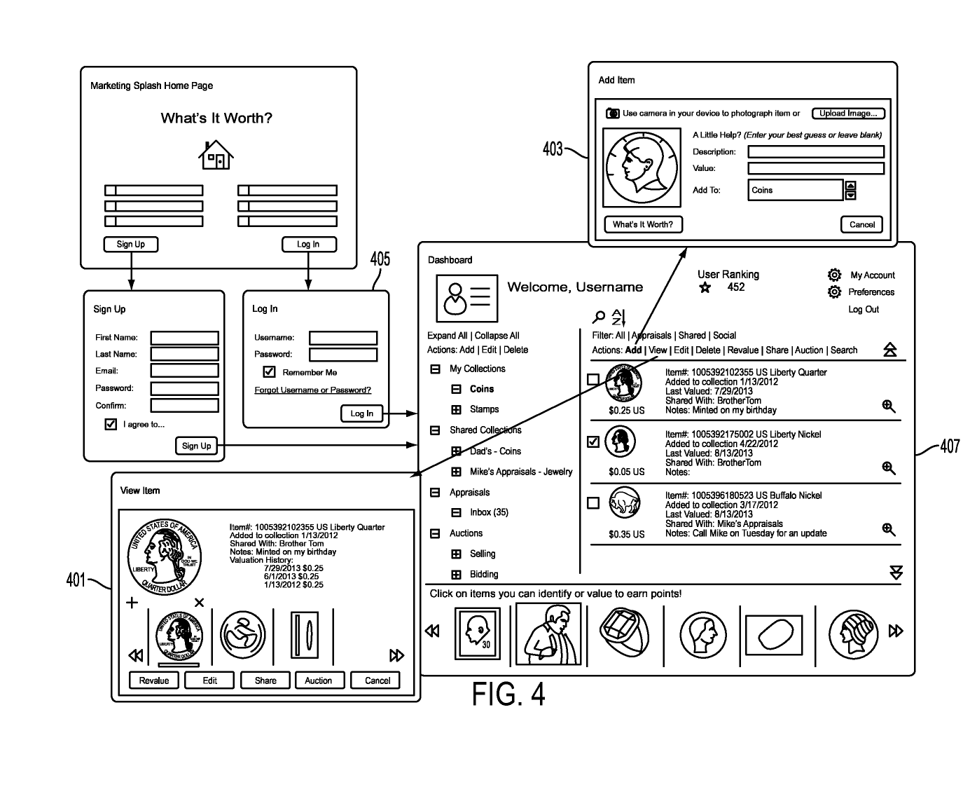

FIG. 4 illustrates components that may be included in a user interface portion of the system. The interface may require a user to enter authentication data through a security interface 405. Items may be represented by “view item” widgets 401 that, when selected or contacted by a mouse, pointer or touch screen input, provide information about the item such as identifying information, category and/or value. Optionally, items may be displayed in a stacked format so that rolling the cursor over the stack, or swiping a finger over the stack on a touch screen, causes the display to flip through items in the stack. An “add item” widget 403 can contain the data fields of a “view item” widget, but it can include one or more input fields that allow the user to add details appropriate for the class of item. For example, when the user uses the electronic device to captures a photo of a target object, it may display the object in an “add item” widget and give the user options to view available data based on the system's recognition of the object (if available), add identifying data or categorical data, upload the item to the user's collection, or request valuation data after confirming the identity of the target object. This widget also may include a “need a little help” wizard that asks the user to confirm, correct or reject system-identified candidate information. A collections widget 407 may allow the user to see a list, thumbnails or other representations of multiple items in a collection, and then select any of those items to see more detailed information, such as via the view item widget 401.

Optional additional features that the user interface may present to the user include an ability to remove an item from the database, as well as the ability to offer the item to other users for trade, sale or auction. The system may also offer the user an ability to request that an item be appraised, such as by an appraiser who is certified or who has at least a threshold score level in the system. This option allows expert appraisals and crowdsourced appraisals. The system may charge the user a fee for expert/certified appraisals.

Appraisers also may register to use the system and be notified when the system receives a new expert appraisal request. The system may store categorical and score data for the appraiser to determine what types of items that an appraiser has experience with or appraises in a high-scoring manner. It may then direct expert appraisal requests for items that are in the appraiser's area of expertise to that appraiser, or it may choose the highest-ranked and most-experienced-in-the-category appraiser if multiple appraisals are willing to review a target object.

Optionally, when presenting appraisal opportunities to a group of appraisers, the system may enable each appraiser to submit a bid with a price for performing the appraisal. The system may collect all received bids and automatically select those that meet one or more criteria established by the system or receive from the owner. Suitable criteria may include, for example, the lowest bid, a second-lowest bid, a bid that is lowest but not more than a specified deviation from an average or mean of all bids, a function that considers both the amount of the bid and the experience level of the appraiser, or other criteria. Alternatively, the system may present all bids to the owner for selection of a winning bidder by the owner.

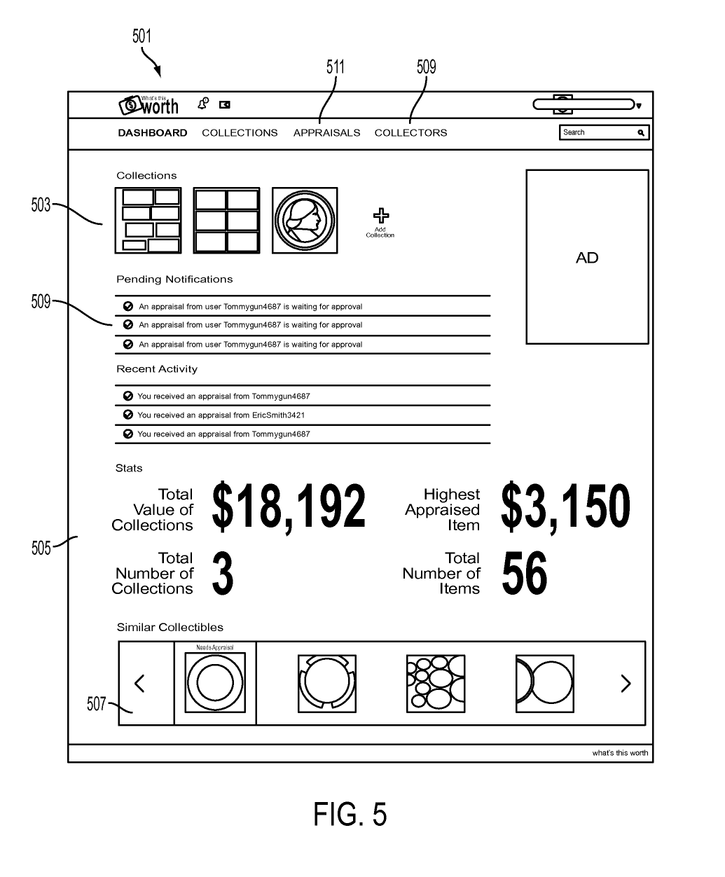

Optionally, the system may include a social function in which users can connect and share data about their collections. If so, connected users may be permitted to view each other's collections and search for items. For example, The dashboard discussed above in FIG. 3 may include a “view collections” option that makes available information about collections of other users who have made their collections available for viewing by the public, or by individual users or groups of users with whom they are linked on the system, or by specifically selected users to whom they have given viewing authorization. FIG. 5 illustrates an example page of a dashboard 501 in which the system enables the user to view, add or modify data about the user's collection 503 along with various statistics 505 about the user's collections. The system may also include user-selectable prompts about other items 507 from other collections that have one or more characteristics that are similar to items in the user's collections. The system may enable the user to access appraisal data 511 about items in any of the user's collections. The dashboard may also enable to user to access collections data about other collectors 509 who are registered with the system and who are either linked to the user (such as via mutual consent) or who make one or more collections publicly available for viewing on the system.

The dashboard may also include a user-selectable prompt in which the user may request an appraisal of a particular item, and if so the system will transmit a request for appraisal to one or more users of the system who are classified as appraisers. Alternatively or in addition, the system may automatically request an appraisal from other users when a first user adds an item to his or her collection catalog. A notification section 509 of the user dashboard may include notifications of when appraisals are received from one or more appraisers. In addition, the appraiser dashboard (described below) also may include a notification system that notifies appraisers when new appraisal requests are received. Each dashboard also may include messaging functions that enable the requesting user and the appraiser to communicate with each other. For example, an appraiser may use the messaging function to acknowledge or accept an appraisal request, to ask the requesting user for more information about the object, or to provide other communications. Optionally, the system may place a time threshold on each appraisal request so that if an appraiser does not accept an appraisal request or provide an appraisal within a specified period of time, the request will be withdrawn from the appraiser when that period of time elapses. When the user who added the object to his or her collection receives appraisals, the user optionally may be able to selectively include or exclude one or more of the appraisals from his or her catalog.

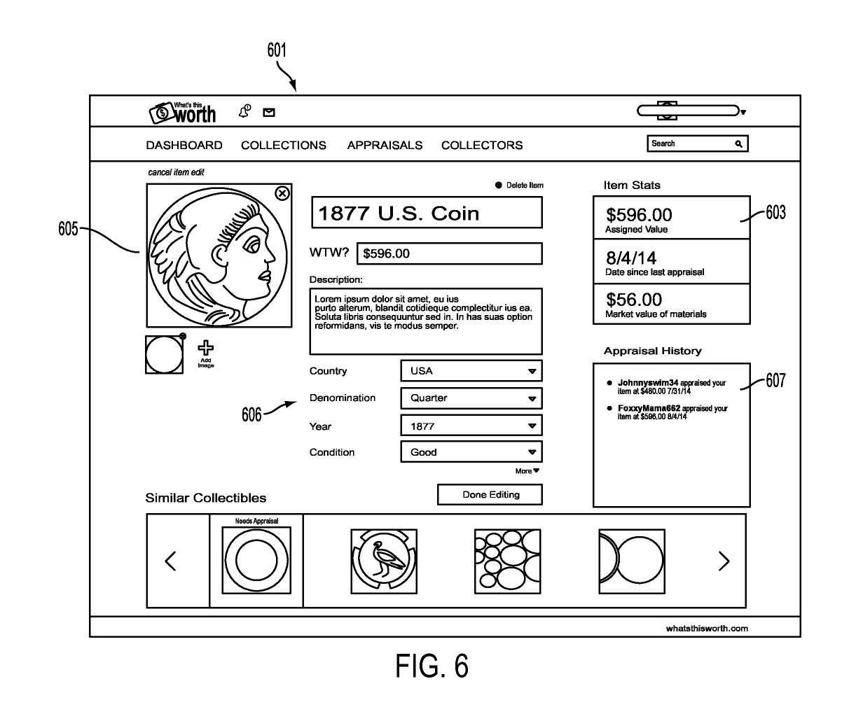

FIG. 6 illustrates an example dashboard page 601 by which the system may enable a user to view, add or edit information about a particular object in his or her collection. The page may display an image(s) 605 of the object, either as taken by the user or as retrieved from the data set. The system also may display information about one or more attributes of the object 606 such as year, country of origin, descriptive information, condition, value, and other information. The system may retrieve this information from its database, based on data previously received from the user or other users. The user may also use this dashboard page to add or modify the attributes, and if so the system will save the updated information to its database for use when presenting the object to the user and/or other users in the future. This page also may display appraisal data 603 for the object, such as an appraised value and a date of the appraisal. The page also may show a history of other appraisals received for the object 607, if such data is available. The system may calculate the current appraisal value to display using any suitable method, such as by using the most recent appraisal received, by determining an average or mean value of all appraisals received during a specific recent time period, or by determining an average or mean value of a particular number of most recent appraisals received.

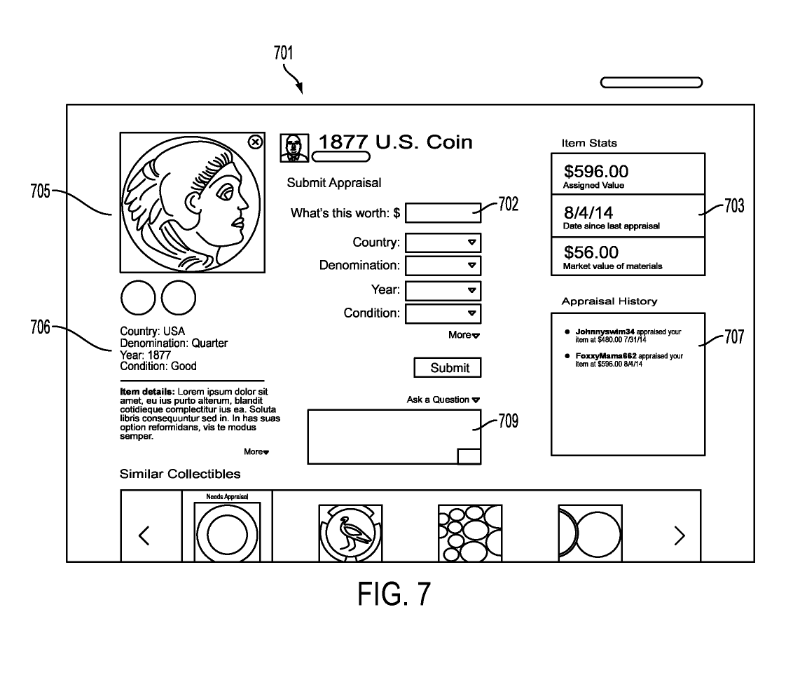

FIG. 7 illustrates an example dashboard page 701 by which the system may enable an appraiser to view information about a particular object and submit an appraisal of the object. The page may display an image(s) 705 of the object as retrieved from the data set, along with information about one or more attributes of the object 706 such as year, country of origin, descriptive information, condition, value, and other information. The system may retrieve this information from its database, based on data previously received from users. The user may also use this dashboard page to add an appraisal 702 and/or add or modify information about one or more attributes of the object. The appraisal may be entered in a data field as shown, or the data entry field may be a selectable input device, such as a sliding scale, drop-down menu, or other mechanism that provides an upper and/or lower boundary for the appraisal. When the appraisal is received, the system will save the updated information to its database for use when presenting the object to the user and/or other users in the future.

This page also may display previously-received appraisal data 703 for the object, such as an appraised value and a date of the appraisal, along with a history of other appraisals received for the object 707, if such data is available. The system may calculate the current appraisal value to display using any suitable method, such as by using the most recent appraisal received, by determining an average or mean value of all appraisals received during a specific recent time period, or by determining an average or mean value of a particular number of most recent appraisals received. The appraiser dashboard also may include fields that permit the appraiser to send a question to the object's owner via a messaging service, or to submit a bid (i.e., a proposed or actual fee) for the appraiser's service.

As noted previously, the system may automatically select an appraiser or appraiser for an item or the system may present a group of candidate appraisers to a user and permit a user to select an appraiser or subset of appraisers from the group. The appraisal process can be started without actually delivering items to an appraiser and then only providing only those items that warrant additional examination. Instead, the appraisal can be done online by presenting the photograph of the item to the appraiser. Alternatively, in some embodiments, the system may include message fields 709 that enable an owner and appraiser to communicate with each other and share mailing information so that the owner can send the actual item to the appraiser's mailing address if the appraiser needs to inspect the physical item for review.

If the owner or other user sends a physical item to an appraiser for valuation, the system may prompt the user to take an initial photo 705 of the item and upload the initial photo to the system. The system may also require the user to take another photo of the item after the user receives the item back from the appraiser. The system may then use any known image processing algorithms to analyze each instance of the image and compare image attributes to determine whether each photo actually is of the same item, or whether the item may have been replaced with a substitute or counterfeit item at any stage in the process.

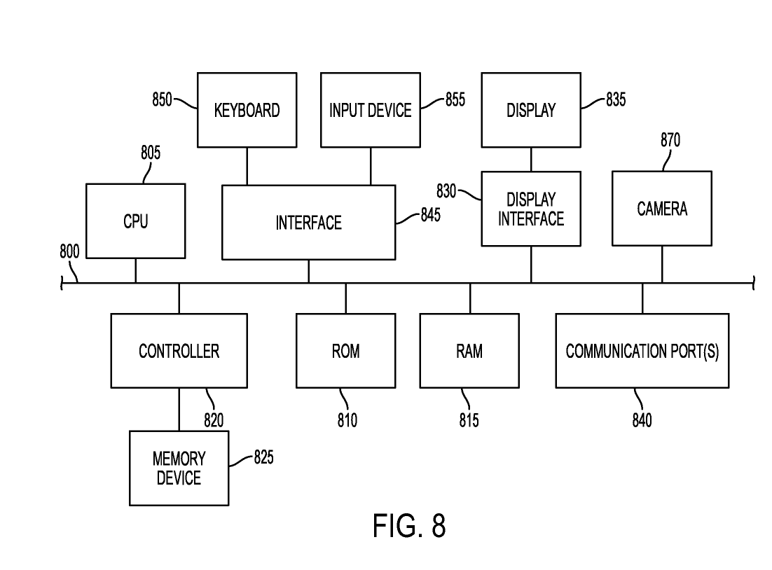

FIG. 8 depicts an example of internal hardware that may be used to contain or implement the various computer processes and systems as discussed above. An electrical bus 800 serves as an information highway interconnecting the other illustrated components of the hardware. CPU 805 is a central processing unit of the system, performing calculations and logic operations required to execute a program. CPU 805, alone or in conjunction with one or more of the other elements disclosed above, is a processing device, computing device or processor as such terms are used within this disclosure. When this description and its associated claims use the term “processor,” unless specifically stated otherwise it may include a single processor, or it may include a set of two or more processors with different processors performing different functions or the same functions. Read only memory (ROM) 810 and random access memory (RAM) 815 constitute examples of memory devices.

A controller 820 interfaces with one or more optional memory devices 825 that service as data storage facilities to the system bus 800. These memory devices 825 may include, for example, an external DVD drive or CD ROM drive, a hard drive, flash memory, a USB drive or another type of device that serves as a data storage facility. As indicated previously, these various drives and controllers are optional devices. Additionally, the memory devices 825 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 810 and/or the RAM 815. Optionally, the program instructions may be stored on a tangible computer readable medium such as a compact disk, a digital disk, flash memory, a memory card, a USB drive, an optical disc storage medium and/or other recording medium.

A display interface 830 may permit information from the bus 800 to be displayed on the display 835 in audio, visual, graphic or alphanumeric format. Communication with external devices may occur using various communication ports 840. A communication port 840 may be attached to a communications network, such as the Internet, a local area network or a cellular telephone data network.

The hardware may also include an interface 845 which allows for receipt of data from input devices such as a keyboard 850 or other input device 855 such as a remote control, a pointing device, a video input device and/or an audio input device. The device also may include a camera 870 that includes an image sensor and other components to capture and create electronic image files of various objects.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A system for identifying items and managing a collection of items,
the system comprising:
a processor;
a first data storage facility portion containing data relating to a plurality of items and, for each item, identifying data and categorical data;
an image processing module comprising a non-transitory computer-readable memory portion containing programming instructions that, when executed by the processor, cause the processor to:
receive, from a first user, an image of a target object,
process the image to extract one or more identifying characteristics of the target object,
compare the extracted identifying characteristics with the identifying data in the first data storage facility to attempt to identify one or more items having identifying data that matches at least a threshold portion of the extracted identifying characteristics, and
classify any identified one or more items in the database as a probable match with the target object; and
an object identification confirmation module comprising a non-transitory computer-readable memory portion containing programming instructions that, when executed by the processor, cause the processor to:
if one or more probable match items were identified in the comparing step, return the identifying data for each probable match item to the first user and request that the first user confirm which, if any, of the probable match items corresponds to the target object,
if no probable match items were identified in the comparing step, or if the first user does not confirm that any of the probable match items corresponds to the target object, then:
send the image of the target object to a plurality of additional users for identification,
receive crowdsourced identifying data from at least one of the additional users,
add at least some of the crowdsourced identifying data to the first data storage facility portion, and
return the crowdsourced identifying data to the first user.

2. The system of claim 1, wherein:
the first data storage facility portion also comprises valuation data for at least some of the plurality of items; and
the system further comprises an automated appraisal module comprising instructions that, when executed, cause the processor to perform the following analysis for a selected one or more of the identified probable match items:
determine whether the first data storage facility portion includes stored valuation data for the selected probable match item;
if the first data storage facility portion includes valuation data for the selected probable match item, return the stored valuation data to the first user;
send the image of the target object, the identifying information for the selected probable match item, or both one or more additional users for valuation;
receive, from at least one of the additional users, crowdsourced valuation data;
add at least some of the crowdsourced valuation data to the first data storage facility portion as new valuation data for the target object; and
return the crowdsourced valuation data to the first user.

3. The system of claim 1, wherein the instructions of the object identification module further comprise instructions that, when executed, cause the processor to:
receive, from the first user, user-supplied identifying characteristics and user-supplied category information; and
when identifying the one or more items in the database that are a probable match with the target object, also compare the user-supplied identifying characteristics to the identifying data in the first data storage facility to identify one or more items having identifying data that matches at least a threshold portion of the user-supplied identifying characteristics, and also use the user-supplied category information and require that the identified items have categorical data that corresponds to the user-supplied category information.

4. The system of claim 1, further comprising:
a second data storage facility portion containing a catalog of a plurality of first user items that are part of a collection that is associated with the first user; and
additional programming instructions that, when executed, cause the processor to add the image, identifying information, and categorical information for the probable match item to the catalog as a catalogued item for the first user upon receipt of the confirmation from the first user that the probable match items corresponds to the target object.

5. The system of claim 2, wherein:
the crowdsourced valuation data comprises, for each additional user from whom crowdsourced valuation data is received, an appraised value for the target object; and
the automated appraisal module also comprises instructions that, when executed, cause the processor to:
present, to the first user, each of the received appraised values,
receive, from the first user, a selection of one of the received appraised value or an average or mean of each of the appraised values, and
add the user selection to a data set that includes identifying and valuation data for a collection of the objects for the first user.

6. The system of claim 2, wherein the automated appraisal module further comprises programing instructions that cause the processor to implement a messaging function that enables any of the additional users to send the first user a request for supplemental information about the target object, receive the supplemental information in response to the request, and display the supplemental information to the additional user for use in generating the crowdsourced valuation data.

7. The system of claim 1, further comprising:
a data set comprising a collection of objects that are associated with the user and, for each object, identifying data and valuation data; and
wherein the system further comprises a memory portion containing programming instructions that, when executed, cause the processor to do either or both of the following:
add at least a portion of the crowdsourced identifying data to the data set in association with the target object, and
add at least a portion of the crowdsourced valuation data to the data set in association with the target object.

8. The system of claim 6, wherein the automated appraisal module further comprises programing instructions that:
enable an additional user to request the first user to send the actual target object to a delivery address;
prior to delivery of the target object to the delivery address, require the first user to provide an initial image of the target object;
after return of the target object to the first user, require the first user to provide a final image of the target object;
process the initial image and the final image to extract one or more additional characteristics of each image;
compare the extracted additional characteristics to the extracted identifying characteristics to determine whether any differences exist that would indicate that the target object may have been replaced with a different object; and
return a report to the first user indicating whether any differences exist that would indicate that the target object may have been replaced with a different object.

9. A system for managing a collection of items, the system comprising:
a processor;
a first data storage facility portion containing data relating to a plurality of items and, for each item, identifying data;
an image processing module comprising a non-transitory computer-readable memory portion containing programming instructions that, when executed by the processor, cause the processor to:
receive, from a first user, an image of a target object,
analyze the image to determine one or more attributes of the object, and
determine identifying information for the target object by using the determined one or more attributes to retrieve identifying information for the target object from the first data storage facility portion; and
an automated appraisal module comprising a non-transitory computer-readable memory portion containing programming instructions that, when executed by the processor, cause the processor to:
send the image of the target object and the identifying information to a plurality of additional users for valuation,
receive, from at least one of the additional users, crowdsourced valuation data,
add at least some of the crowdsourced valuation data to the first data storage facility portion as new valuation data for the target object, and
return the crowdsourced valuation data to the first user.

10. The system of claim 9, wherein the instructions that cause the processor to determine identifying information for the target object comprise instructions to:
process the image to identify one or more characteristics of the target object; and
identify one or more items in the database that are a probable match with the target object by comparing the characteristics to the identifying data in the first data storage facility to identify one or more items having identifying data that matches at least a threshold portion of the characteristics;
if one or more probable match items are identified, return the identifying data for each categorical item to the first user and request that the first user confirm which, if any, of the probable match items correspond to the target object;
if no probable match items are identified, or if the first user does not confirm that any of the probable match items corresponds to the target object:
send the image of the target object to the plurality of additional users for identification,
receive, from at least one of the additional users, crowdsourced identifying data,
add at least some of the crowdsourced identifying data to the first data storage facility portion, and
use the crowdsourced identifying data as the identifying information.

11. The system of claim 10, wherein the instructions of the object identification module further comprise instructions that, when executed, cause the processor to:
receive, from the first user, user-supplied identifying characteristics and user-supplied category information; and
when identifying the one or more items in the database that are a probable match with the target object, also compare the user-supplied identifying characteristics to the identifying data in the first data storage facility to identify one or more items having identifying data that matches at least a threshold portion of the user-supplied identifying characteristics, and also use the user-supplied category information and require that the identified items have categorical data that corresponds to the user-supplied category information.

12. The system of claim 10, further comprising:
a second data storage facility portion containing a catalog of a plurality of first user items that are part of a collection that is associated with the first user; and
additional programming instructions that, when executed, cause the processor to add the image, identifying information, and categorical information for the probable match item to the catalog as a catalogued item for the first user upon receipt of the confirmation from the first user that the probable match item corresponds to the target object.

13. The system of claim 9, wherein:
the crowdsourced valuation data comprises, for each additional user from whom crowdsourced valuation data is received, an appraised value for the target object; and
the automated appraisal module also comprises instructions that, when executed, cause the processor to:
present, to the first user, each of the received appraised values,
receive, from the first user, a selection of one of the received appraised value or an average or mean of each of the appraised values, and
add the user selection to a data set that includes identifying and valuation data for a collection of the objects for the first user.

14. The system of claim 9, wherein the automated appraisal module further comprises programing instructions that cause the processor to implement a messaging function that enables any of the additional users to send the first user a request for supplemental information about the target object, receive the supplemental information in response to the request, and display the supplemental information to the additional user for use in generating the crowdsourced valuation data.

15. The system of claim 10, further comprising:
a data set comprising a collection of objects that are associated with the user and, for each object, identifying data and valuation data; and
wherein the system further comprises a memory portion containing programming instructions that, when executed, cause the processor to do one or both of the following:
add at least a portion of the crowdsourced identifying data to the data set in association with the target object, and
add at least a portion of the crowdsourced valuation data to the data set in association with the target object.

16. The system of claim 9, wherein the automated appraisal module further comprises programing instructions that cause the processor to:
enable an additional user to request the first user to send the actual target object to a delivery address;
prior to delivery of the target object to the delivery address, request the first user to capture an initial image of the target object;
after return of the target object to the first user, request the first user to provide a final image of the target object;
process the initial image and the final image to extract one or more additional characteristics of each image;
compare the extracted additional characteristics to extracted identifying characteristics to determine whether any differences exist that would indicate that the target object may have been replaced with a different object; and
return a report to the first user indicating whether any differences exist that would indicate that the target object may have been replaced with a different object.

17. A method of managing a collection of items, comprising:
by an image processing module comprising computer-readable programming instructions configured to be executed by a processor:
receiving an image of a target object from a first user,
analyzing the image to determine one or more attributes of the object,
processing the image to identify one or more characteristics of the target object,
identifying one or more items in the database that are a probable match with the target object by comparing the characteristics to the identifying data in the first data storage facility to identify one or more items having identifying data that matches at least a threshold portion of the characteristics,
if one or more probable match items are identified, returning the identifying data for each categorical item to the first user and request that the first user confirm which, if any, of the probable match items correspond to the target object,
if no probable match items are identified, or if the first user does not confirm that any of the probable match items corresponds to the target object:
sending the image of the target object to the plurality of additional users for identification,
receiving, from at least one of the additional users, crowdsourced identifying data,
adding at least some of the crowdsourced identifying data to the first data storage facility portion, and
using the crowdsourced identifying data as the identifying information, and
returning the identifying information to the first user; and
by an automated appraisal module:
sending the image of the target object and the identifying information to a plurality of additional users for valuation,
receiving, from at least one of the additional users, crowdsourced valuation data,
adding at least some of the crowdsourced valuation data to the first data storage facility portion as new valuation data for the target object, and
returning the crowdsourced valuation data to the first user.

18. The method of claim 17, further comprising:
receiving, from the first user, user-supplied identifying characteristics and user-supplied category information; and
when identifying the one or more items in the database that are a probable match with the target object, also comparing the user-supplied identifying characteristics to the identifying data in the first data storage facility to identify one or more items having identifying data that matches at least a threshold portion of the user-supplied identifying characteristics, and also use the user-supplied category information and require that the identified items have categorical data that corresponds to the user-supplied category information.

19. The method of claim 17, further comprising adding the image, identifying information, and categorical information for the probable match item to a catalog of collected items for the first user upon receipt of the confirmation from the first user that the probable match item corresponds to the target object.

20. The method of claim 17, further comprising, by the automated appraisal module:
enabling an additional user to request the first user to send actual the target object to a delivery address;
prior to delivery of the target object to the delivery address, requesting the first user to capture an initial image of the target object;
after return of the target object to the first user, requesting the first user to capture a final image of the target object;
processing the initial image and the final image to extract one or more additional characteristics of each image;
comparing the extracted additional characteristics to extracted identifying characteristics to determine whether any differences exist that would indicate that the target object may have been replaced with a different object; and
returning, to the first user, a report indicating whether any differences exist that would indicate that the target object may have been replaced with a different object.

21. The method of claim 17, further comprising, by the automated appraisal module:
enabling each of a plurality of the additional users to submit a bid for appraising the target object;
after receiving a plurality of bids, comparing the bids to one or more selection criteria, and
presenting the bids that meet the selection criteria to the first user.

22. The method of claim 17, further comprising, by the image processing module:
receiving an image of a second candidate object from a second user;
processing the image to identify one or more identifying characteristics of the second candidate object;
searching the database to determine whether any target object in the database has characteristics that match the identifying characteristics; and
if one or more target object in the database have characteristics that match the identifying characteristics, returning identifying data for each such target object item, along with a history of previous valuation data or ownership data for the target object.
